(19) United States
(12) Patent Application Publication
(10) Pub. No.: US 2004/0252349 A1
(43) Pub. Date: Dec. 16, 2004

(54) Fax routing based on caller-ID

(76) Inventors: Brett A. Green, Meridian, ID (US); Curtis Reese, Boise, ID (US); John R. Hatten, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/448,657

(22) Filed: May 29, 2003

(51) Int. Cl. H04N 1/00; G06F 15/16

(52) U.S. Cl. 358/440; 709/206; 358/1.15

(57) ABSTRACT

A method for sorting facsimiles includes identifying an originating phone number from which the facsimile originates, and routing the facsimile based on the identified originating phone number. The facsimile is routed to an E-mail location, to a storage medium or to a selected output slot on a facsimile device. In some embodiments, the method includes mapping the originating telephone number to facsimile destination or destinations. A facsimile device includes a processor, a memory, and a data reader adapted to identify an originating phone number from data associated with a ring signal. A system for sorting facsimiles includes a processor, a storage device, and software operable on the processor to identify an originating phone number from which the facsimile originates, and route the facsimile based on the identified originating phone number. A computer-usable storage medium has a computer program thereon for causing a suitably configured information-handling system to sort facsimiles received by a facsimile device by performing the following steps when such program is executed on the system: identify an originating phone number from which the facsimile originates, and route the facsimile based on the identified originating phone number.

### FIELD OF THE INVENTION

The present invention relates to fax or facsimile machines, or multi-function machines that include fax or facsimile functions. In particular, the present invention relates to a method and apparatus for routing faxes or facsimiles based on caller-id.

### BACKGROUND OF THE INVENTION

Faxing information or documents from one party to another party is a very common occurrence these days. There are difficulties in this process. In most office environments, a single facsimile machine is rarely dedicated to a single user since the facsimile machine will be under utilized. Most often, a facsimile machine is used by a number of different people in an office. In such an environment, one of the difficulties is sorting the faxes among the number of people using a facsimile machine. In one instance, the fax output is paper. In other instances, the fax output may be an image that can be E-mailed to a recipient. In each case, the incoming faxes must be manually routed to a recipient. In the case of paper output, a person must review each of the facsimiles received to determine the party to receive the facsimile. The person must separate the facsimile from other facsimiles and then place the facsimile in a mailbox or on the recipient's desk or the like. In the case of facsimiles received as an electronic image, a person must open the file associated with the image of the facsimile to determine the recipient and then forward the image file to the recipient by E-mail or print out the image and place the facsimile in the recipient's mail box or the like.

In either instance, the process requires someone to determine who the recipient is from the facsimile. This requires time, and is prone to errors. Errors include forwarding an image to the wrong E-mail address or placing a paper copy of the facsimile into the wrong mailbox or onto the wrong desk. Of course, the sorting process becomes increasing difficult as the number of people using the facsimile machine grows. In addition, as the process gets more complex, the number of errors also grows. Of course, when there are errors, the flow of business is interrupted with predictable inefficiencies and upset individuals. Still another problem is that facsimiles containing confidential information must be opened by someone in order to sort them. In some instances, it may not be desirable for the person sorting the facsimiles to see the content of the facsimiles.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is a schematic diagram of a computer system, according to an embodiment of this invention.

FIG. 2 is a schematic diagram of a computer system integrated into a facsimile machine or into a multiple function peripheral device, according to an embodiment of this invention.

FIG. 3 shows a representation of a message received by a data receiver of a facsimile machine or multifunction peripheral device, according to an embodiment of the invention.

FIG. 4 is a schematic diagram of a computer system separate from a facsimile machine, or integrated into a facsimile or a multiple function peripheral device, according to embodiments of this invention.

FIG. 5 is a schematic diagram showing a facsimile device and a data receiver, according to an embodiment of this invention.

FIG. 6 is a flow chart including a method for routing a facsimile received at a facsimile device, according to an embodiment of this invention.

FIG. 7 is a flow chart including a method for routing a facsimile received at a facsimile device, according to another embodiment of the invention.

FIG. 8 is a block diagram of a computer readable medium that includes an instruction set thereon.

FIG. 9 is a screen shot of a user interface associated with an embedded web server embedded into the hardware of the facsimile device, according to an embodiment of this invention.

### BRIEF DESCRIPTION OF THE INVENTION

In the following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents. The following description is, therefore, not to be taken in a limited sense, and the scope of the present invention is defined by the appended claims.

The functions described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples.

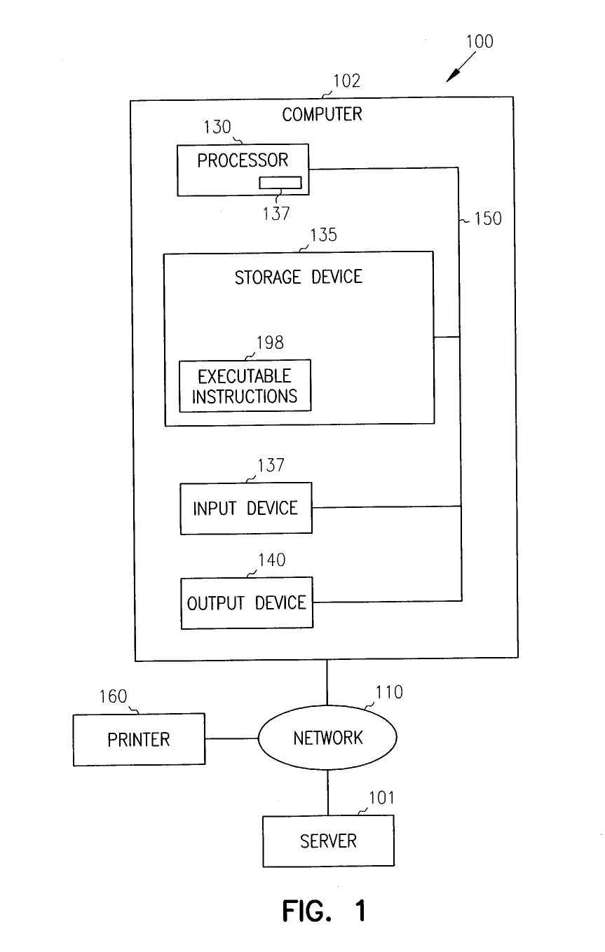

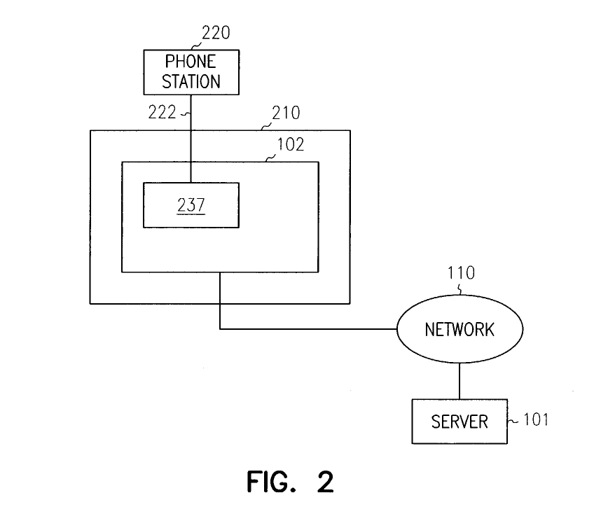

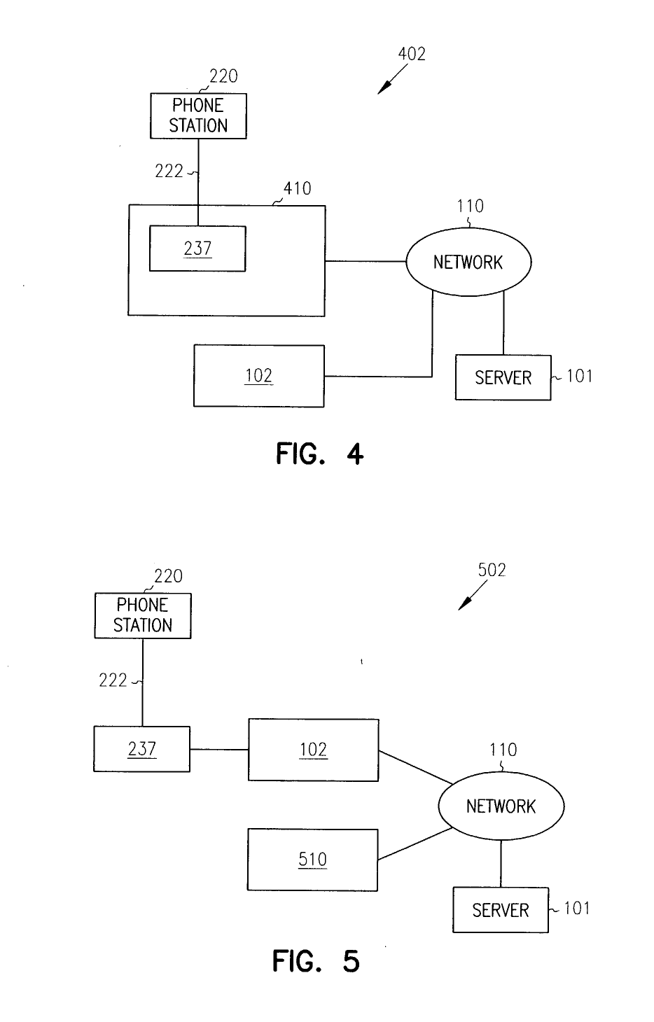

FIG. 1 is a schematic diagram of an electronic device 100. The electronic device 100 includes a computer system 102 according to an embodiment of this invention. The computer system 102 includes a processor 130 and a storage device 135. The storage device 135 includes executable instructions 198. The executable instructions 198 are stored within the storage device 135. In one embodiment, the computer system 102 is integrated into a facsimile machine or into a multiple function peripheral device 210 that includes a facsimile machine or which includes software or firmware that provides the multiple function peripheral machine to include facsimile function (shown in FIG. 2). In another embodiment, the computer system 102 is separate from the facsimile machine or multiple function peripheral 210 (shown in FIG. 4). The electronic device 100 includes a network 110 and a server 101. The computer system 102 is communicatively coupled to the network 110. The network 110 and the computer 102 are communicatively coupled to the server 101. Other peripheral devices can also be attached to the network 110.

The processor 130 represents a central processing unit of any type of architecture, such as a CISC (Complex Instruction Set Computing), RISC (Reduced Instruction Set Computing), VLIW (Very Long Instruction Word), or hybrid architecture, although any appropriate processor may be used. The processor 130 executes instructions and includes that portion of the electronic device 101 that controls the operation of the entire electronic device. Although not depicted in FIG. 1, the processor 130 typically includes a control unit 137 that organizes data and program storage in memory and transfers data and other information between the various parts of the electronic device 101. The processor 130 receives input data from the input device 137 and the network 110, reads and stores code and data in the storage device 135, and presents data to an output device 140 and/or the network 110.

Although the electronic device 100 is shown to contain only a single processor 130 and a single bus 150, the present invention applies equally to electronic devices that may have multiple processors and multiple buses with some or all performing different functions in different ways.

The storage device 135 represents one or more mechanisms for storing data. For example, the storage device 135 may include read only memory (ROM), random access memory (RAM), magnetic disk storage media, optical storage media, flash memory devices, and/or other machine-readable media. In other embodiments, any appropriate type of storage device may be used. Although only one storage device 135 is shown, multiple storage devices and multiple types of storage devices may be present, and in various embodiments some or all of the product codes, the controller 137, and the products may be stored on the same or on different storage devices. Further, although the electronic device 100 is drawn to contain the storage device 135, it may be distributed across other electronic devices, for example on computers attached to the network 110.

The controller 137 includes instructions capable of being executed on the processor 130 to carry out the functions of the present invention. In another embodiment, some or all of the functions of the present invention are carried out via hardware in lieu of a processor-based system.

The input device 137 may be a keyboard, mouse or other pointing device, trackball, touchpad, touchscreen, keypad, microphone, voice recognition device, data recorder, data recognition device or any other appropriate mechanism for the user to input data to the electronic device 100. Although one input device 137 is shown, in another embodiment any number (including none) and type of input devices may be present.

The output device 140 is that part of the electronic device 100 that communicates output to the user. The output device 140 may be a cathode-ray tube (CRT) based video display. But, in other embodiments the output device 140 may be replaced with a liquid crystal display (LCD) based or gas, plasma-based, flat-panel display. In another embodiment, the output device 140 may be a speaker. In still other embodiments, any appropriate output device may be used. Although one output device 140 is shown, in other embodiments, any number (including none) of output devices of different types or of the same type may be present. In one embodiment, the output device is part of the facsimile or multi-function peripheral 210. In another embodiment, the output device is a separate, stand-alone device.

The bus 150 may represent one or more busses, e.g., PCI, ISA (Industry Standard Architecture), X-Bus, EISA (Extended Industry Standard Architecture), or any other appropriate bus and/or bridge (also called a bus controller).

The electronic device 100 may be implemented using any suitable hardware and/or software, such as a personal computer. Portable computers, laptop or notebook computers, PDAs (Personal Digital Assistants), pocket computers, telephones, pagers, appliances, and mainframe computers are examples of other possible configurations of the electronic device 101. The hardware and software depicted in FIG. 1 may vary for specific applications and may include more or fewer elements than those depicted. For example, other peripheral devices such as audio adapters or chip programming devices, such as EPROM (Erasable Programmable Read-Only Memory) programming devices may be used in addition to or in place of the hardware already depicted.

The network 110 may be any suitable network and may support any appropriate protocol suitable for communication between the electronic device 100 and the printer 160 or other electronic devices, such as a facsimile device or multi-function peripheral device that includes a facsimile device. In an embodiment, the network 110 may support wireless communications. In another embodiment, the network 110 may support hard-wired communications, such as a telephone line or cable. In another embodiment, the network 110 may support the Ethernet IEEE (Institute of Electrical and Electronics Engineers) 802.3x specification. In another embodiment, the network 110 may be the Internet and may support IP (Internet Protocol). In another embodiment, the network 110 may be a local area network (LAN) or a wide area network (WAN). In another embodiment, the network 110 may be a hotspot service provider network. In another embodiment, the network 110 may be an intranet. In another embodiment, the network 110 may be a GPRS (General Packet Radio Service) network. In another embodiment, the network 110 may be any appropriate cellular data network or cell-based radio network technology. In another embodiment, the network 110 may be a wireless network. In still another embodiment, the network 110 may be any suitable network or combination of networks. Although one network 110 is shown, in other embodiments any number of networks (of the same or different types) may be present.

Aspects of an embodiment pertain to specific apparatus and method elements implementable on a computer or other electronic device. In another embodiment, the invention may be implemented as a program product for use with an electronic device. The programs defining the functions of this embodiment may be delivered to an electronic device via a variety of signal-bearing media, which include, but are not limited to:

(1) information permanently stored on a non-rewriteable storage medium, e.g., a read-only memory device attached to or within an electronic device, such as a CD-ROM readable by a CD-ROM drive;

(2) alterable information stored on a rewriteable storage medium, e.g., a hard disk drive or diskette; or

(3) information conveyed to an electronic device by a communications medium, such as through a computer or a telephone network, including wireless communications.

Such signal-bearing media, when carrying machine-readable instructions that direct the functions of the present invention, represent embodiments of the present invention.

FIG. 2 is a schematic diagram of a computer system 102 integrated into a facsimile machine or into a multiple function peripheral device 210, according to an embodiment of this invention. The facsimile machine can be a single function machine or stand alone facsimile device or the facsimile machine may be part of a multiple function peripheral device 210 that includes a facsimile function as well as several other functions. For example, a multi-function peripheral device 210 can include the functions of a facsimile, the functions of a scanner, the functions of a printer, and the functions of a copier. It should be noted that the invention is equally applicable to either a stand alone facsimile machine, facsimile device, or a multiple function peripheral device which includes a facsimile function, among the various functions the device performs.

As shown in FIG. 2, the facsimile device, or multiple function peripheral device 210 includes a computer 102 within the stand alone facsimile device or the multifunction peripheral device 210. Within the computer is a data receiver 237. The data receiver 237 is connected to a phone station 220. The phone station 220 is a switch which receives a phone signal and connects it to an appropriate destination, such as a person's voice handset, a facsimile machine, or a multi-purpose peripheral device. It should be noted that the phone station 220 can be located or controlled by a telephone company, or it can be located and controlled within a company. The phone station 220 produces a ring signal which is carried along line 222 to the data receiver 237. The data receiver 237 includes hardware and software necessary to decode a portion of the ring signal to determine the origin or source phone number from which the facsimile or other data is received. The data receiver 237 includes, as one of its outputs, the origin or source phone number from the ring signal carried on line 222. The output of the data receiver 237 is an input to the computer 102. The input is not shown in FIG. 2, but is shown as an input device 137 in FIG. 1.

Turning again to FIG. 2, the facsimile device or multiple function peripheral device 210 is attached to the network 110. The network, in turn, is attached to the server 101. In one embodiment, Caller ID (“CID”) information or calling number delivery information is used to determine the source or originating phone number of a facsimile. CID information is transmitted on the subscriber loop and within the ring signal using frequency shift keyed (“FSK”) modem tones. The FSK modem tones are used to transmit a message in American Standard Code for Information Interchange (“ASCII”) character code form. The transmission of the message takes place between the first and second ring. In one format, the information sent includes the date, time, and calling number. In another format, the name associated with the calling number is also included.

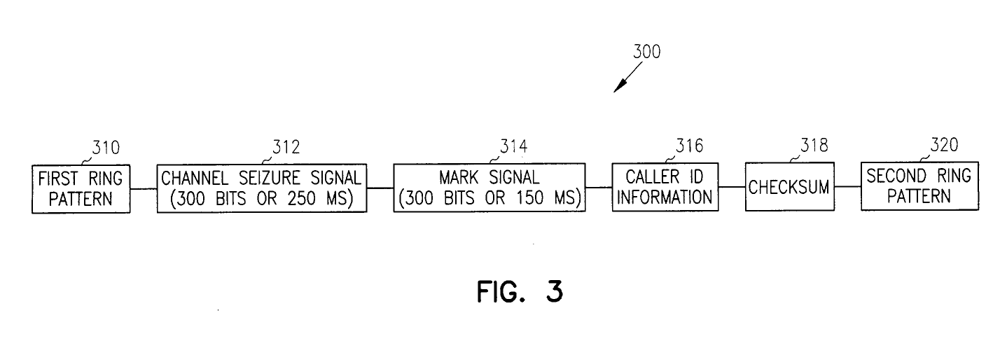

FIG. 3 shows a representation of a message 300. The CID information is sent on the destination subscriber loop and to the data receiver 237 between the first ring pattern 310 and second ring pattern 320 using two modem tones. The information is transmitted serially in FSK mode using one of the tones to represent a logic 1 (mark) and the other to represent a logic 0 (space). The message includes a channel seizure string 312 followed by a mark string 314 and then the CID information 316. The CID information 316 is sent in one of two formats. The Single Data Message Format (SDMF) contains the date, time, and calling number. The Multiple Data Message Format (MDMF) contains the date, time, calling number, and the name associated with that number. The CID information 316 is followed by a check sum word 318 which is used to determine if there is an error in the CID information 316.

FIG. 4 is a schematic diagram of an electronic device 402 that includes a facsimile or multipurpose peripheral device 410 and a separate computer system 102. The facsimile or multifunction peripheral device 410 and the computer 102 are each coupled to a network 110. Also coupled to the network 110 is a server 101. The facsimile or multiple function peripheral device 410 also has a data receiver 237 within the multifunction device or facsimile device 410. A phone station 220 sends a ring signal over line 222 to the data receiver 237. The data receiver 237 can be any type of data receiver including a data receiver capable of demodulating frequency shift keyed modem tones. In this particular embodiment of the invention shown in FIG. 4, the computer system 102 acts across the network 110 to control the facsimile or multiple function peripheral device 410. The output from the data receiver 237 which is the originating phone number associated with a facsimile or other data, is input to the computer 102 via the network 110.

FIG. 5 is a schematic diagram showing a facsimile device 510 and a data receiver 237, according to yet another embodiment of this invention. In this particular embodiment of an electronic device 502, a computer system 102 is connected to the network 110. The facsimile device or the multiple function peripheral device 510 is also separately connected to the network 110. Also connected to the network 110 is the server 101. A data receiver 237 is connected to the computer system 102. A phone station 220 is connected to the data receiver 237 via a line 222. The phone station 220 sends ring signals over the line 222 to data receiver 237. The data receiver 237 determines the origin phone number of data associated with a ring signal and inputs it to the computer system 102. Computer system 102 acts over the network or through the network 110 to control the facsimile device or the multiple function peripheral device 510.

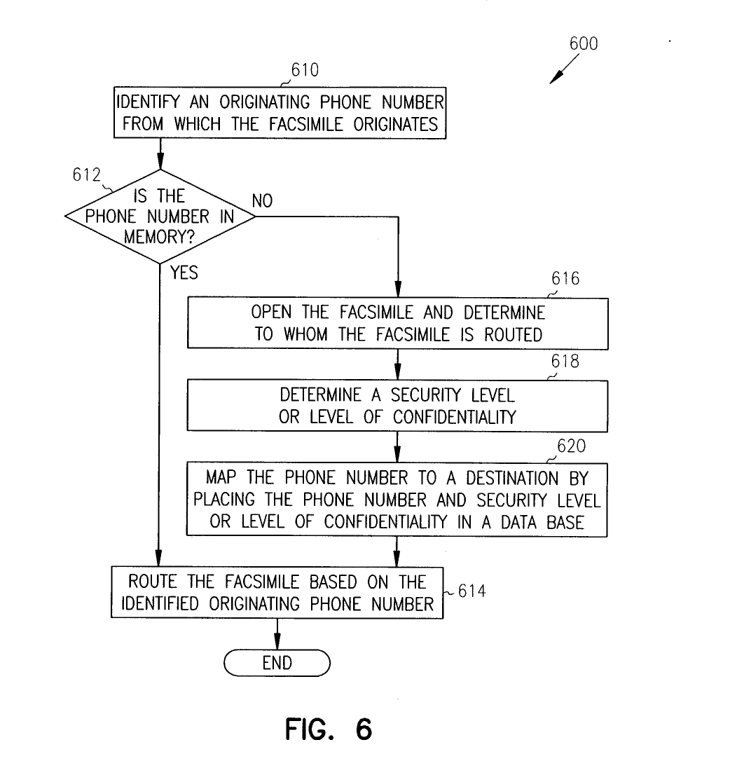

FIG. 6 is a flow chart, including a method 600, for routing a facsimile received by a facsimile device or multiple function peripheral device 210, 410, 510, according to an embodiment of this invention. The administrator of the facsimile device determines the routing of incoming faxes. The routing can be determined automatically using a database that includes fields for an originating phone number and a designated party or parties that generally receive faxes from the originating phone number. In some instances, the routing must be determined manually. In the case of automatic routing, as the facsimile, or other data, is received, an originating phone number from which the facsimile originates is identified, as depicted by reference numeral 610. Once the originating phone number is identified, determination is made whether or not the originating phone number is in the database stored in a memory of the computing device 102, as depicted by reference numeral 612. A look-up table may be placed in the storage device 135 of the computer system 102. The look-up table includes a field for originating phone numbers. If the phone number is in the database, the facsimile is routed based on the identified originating phone number, as depicted by reference numeral 614. The facsimile or other data may be routed to a single destination or to multiple destinations. For example, if a facsimile is generally designated to be received by a group of participants such as a team within an organization, then the facsimile is routed to each of the team members. If, on the other hand, a facsimile from the originating phone number is typically only routed to one recipient within an organization, then the facsimile will be routed to that particular individual. There are several ways in which the facsimile may be routed to an individual or a set of individuals. For example, a facsimile device may be provided with a multiplicity or plurality of trays for hard copy output. In this particular instance, a tray may be designated for one particular user and therefore a hard copy output will be sent to the particular output tray associated with the recipient. In other instances, several copies of the facsimile may be placed in several of the trays when a plurality of recipients is designated or found in a table look up. In other embodiments of the invention, the facsimile may arrive in a scanned mode or format. In this particular instance, a file can be made, such as a .pdf file, and then may be forwarded to an e-mail server. The e-mail server will then forward the file to the recipient or recipients of the facsimile. The e-mail message can include security features to limit access to the message in the event the facsimile is of a secure nature. In yet another instance, the file may be stored in a server 101 and either the recipient or plurality of recipients is given access to the file.

If the phone number is not in the database then the facsimile received is opened or reviewed to determine the recipient to which the facsimile is routed, as depicted by reference numeral 616. A security level or level of confidentiality, if applicable, is then also determined, as depicted by reference numeral 618. The phone number from which the facsimile originated is then stored in a memory location so that it can be made available to the user or administrator to store in the fax sender database, and manually mapped to a destination by placing the phone number in the security level or level of confidentiality in a database in the memory, as depicted by reference numeral 620. Once this is completed, the facsimile is routed based upon the identified originating phone number 614.

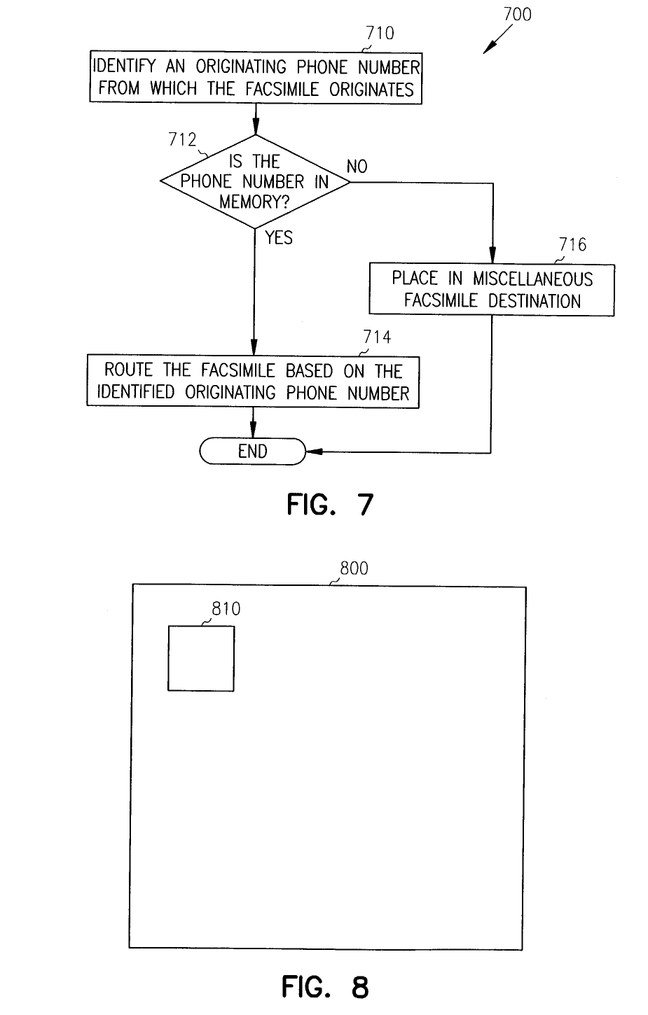

FIG. 7 is a flow chart including a method 700 for routing a facsimile received at a facsimile device or multiple function peripheral device 210, 410, 510, according to another embodiment of the invention. An originating phone number associated with the facsimile is identified, as depicted by reference numeral 710. The memory of the storage device 135 is then reviewed to determine if the phone number associated with the facsimile is in a database or table look up, as depicted by reference numeral 712. If the phone number is in memory, the facsimile is routed based upon the identified originating phone number, as depicted by reference numeral 714. If the phone number is not in memory, the facsimile is placed in a miscellaneous facsimile destination, as depicted by reference numeral 716. Once a facsimile is placed in the miscellaneous facsimile destination, or if it is routed based upon its identified originating phone number, the process ends as depicted by reference numeral 720. It should be noted that method 700 may be one way to treat unknown facsimiles which may be designated as “junk” facsimiles. Another way to treat “junk” facsimiles is to identify the originating phone numbers from which “junk” facsimiles are received, and send them to a file or folder which includes all “junk” facsimiles.

FIG. 7 is also, for all practical purposes, the initial method which is used when implementing this method. In other words, all the facsimiles that have originating phone numbers within the database are routed while all the remaining facsimiles are placed in a miscellaneous bin. The miscellaneous bin or file of facsimiles is reviewed at a later time to determine the appropriate destination for the facsimile. In some instances, the facsimile may be designated as “junk” and the originating phone number can be placed into a database or a record can be made designating that particular facsimile number as sending “junk” facsimiles. In other instances, the destination may go to a user or a number of users until the particular user's bins or emails or files will be designated as an appropriate facsimile destination for the particular originating facsimile number.

The method can be implemented as an instruction set on a computer-readable medium. FIG. 8 is a block diagram of a computer-readable medium 800 that includes an instruction set 810 therein. The computer-readable medium 800 can be any type of memory, a disk used for magnetic disk storage, optical disk storage, flash memory devices, or other machine-readable media. The computer-readable media 800 can also be read-only memory or random-access memory, which is part of a hardware configuration for a computer system. Furthermore, the computer-readable media 800 can also include the internet, storage available to a server, or a transmission of any sort, connected or wireless, that is used to transmit the instructions to a computer system.

A computer-usable storage medium 800 having a computer program or instruction set 810 thereon causes a suitably configured information-handling system or electronic device 100 to sort facsimiles received by a facsimile device or multiple function peripheral device by performing the following steps when the program is executed on the system: identify an originating phone number from which the facsimile originates, and route the facsimile based on the identified originating phone number. In some embodiments, the computer program also includes programming for causing the information handling system to perform the additional step of mapping the originating telephone number to a facsimile destination.

The facsimile is routed to an E-mail location or to a selected output slot on a facsimile device. In some embodiments, the method includes mapping the originating telephone number to facsimile destination. In some embodiments, a security level is designated for selected originating telephone numbers. In still other embodiments, a confidential indication is designated for selected originating telephone numbers. Mapping further includes designating a facsimile destination.

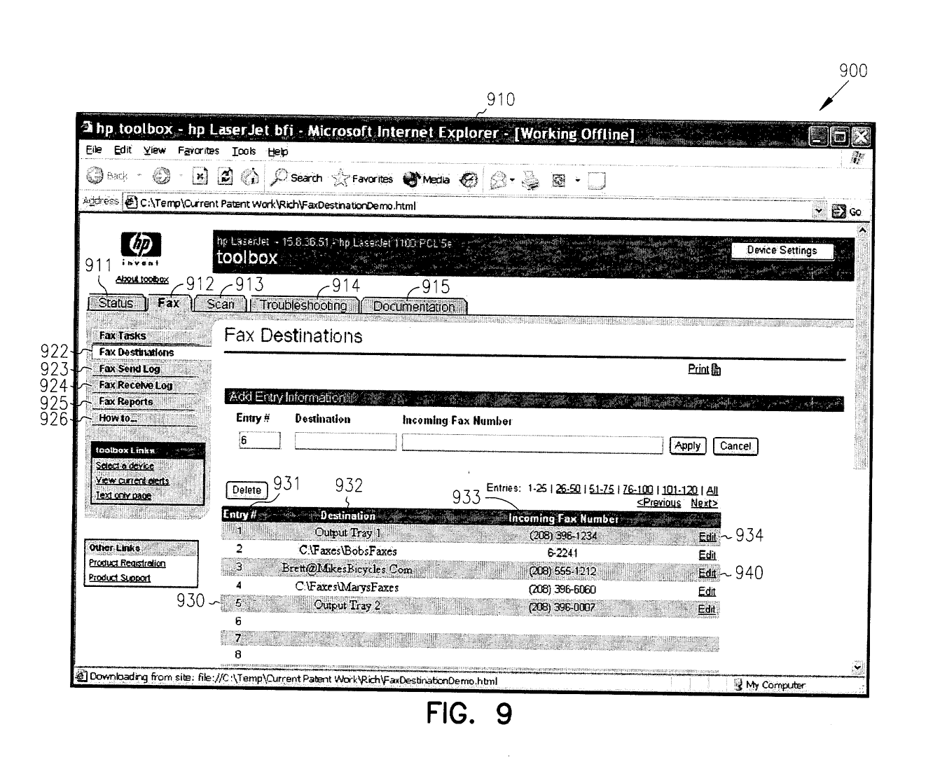

FIG. 9 is a screen shot 910 associated with a web server interface 900 to the facsimile device. The facsimile device or multiple function peripheral device 210, 410, 510 is provided with a web server. The web server is “embedded” into the facsimile device or multiple function peripheral device 210, 410, 510, which means it resides in the hardware or in the firmware of the multiple function peripheral device 210, 410, 510, rather than as software that is loaded on the network server 110.

The web server provides an environment in which web programs may run. The output from these programs can then be displayed and modified by a web browser, such as Microsoft Internet Explorer or Netscape Navigator.

The advantage of an embedded web server is that it provides an interface to the facsimile or multiple function peripheral device 210, 410, 510 that any network-connected PC with a standard web browser can access. If the facsimile administrator has a web browser installed on his or her computer, there is no additional special software to install or configure. The embedded web server displays status information and allows a user to easily add or modify a record 930 of a database 940 from their personal computer. The screen shot 910 of the web server interface 900 includes a status tab 911, a fax tab 912, a scan tab 913, a troubleshooting tab 914, and a documentation tab 915. There are also various buttons including a fax tasks button 921, a fax destinations button 922, a fax send log button 923, a fax receive log 924, a fax reports log 925, and a how-to button 926. As shown in FIG. 9, the fax destinations button 922 has been enabled. This allows the user, such as a facsimile administrator, to add a record 930 to a database 940 of destinations for various fax numbers. Each record 930 includes an entry number 931, a destination label 932, and an incoming fax number 933. As shown in FIG. 9, there are currently five records or five entries 930 in the database 940. Each of the existing records can also be edited as indicated by the edit button 934, associated with each of the individual records. As shown in FIG. 9, a new entry or new record is being added. Below each of the types of information for fields for each record, there is a blank box into which the entry number, the destination, as well as the incoming fax number can be placed. Once the entry or new record is added and a proper destination and an incoming fax number is designated, the user can either choose to apply the record to the database which would make an additional record for the database or the user can choose to cancel the new record.

In some embodiments, mapping further includes designating a facsimile destination over a web page user interface. In some embodiments, a web page user interface is accessed by an embedded web page associated with the facsimile device. The originating phone number associated with the facsimile is obtained by reading calling number identification information associated with the originating phone call. In some embodiments, the calling number identification information is read from information transmitted between the first and second ring of the originating phone call. In other embodiments, the originating phone number is read from a CID associated with the phone call for transmitting the facsimile.

A system for sorting facsimiles includes a processor, a storage device, and software operable on the processor to identify an originating phone number from which the facsimile originates, and route the facsimile based on the identified originating phone number. In some embodiments, the software is further operable on the processor to map the originating telephone number to a facsimile destination or to a plurality of facsimile destinations. In some embodiments, the software is further operable on the processor to create a database that maps the originating telephone number to a facsimile destination. In some embodiments, the software is further operable on the processor to determine a security level associated with the facsimile.

A facsimile device includes a processor, a memory, and a data reader adapted to identify an originating phone number from data associated with a ring signal. In some embodiments, the facsimile device also includes a mechanism for routing the facsimile based on the identified originating phone number to a selected destination or to at least one selected destination. The facsimile device, in some embodiments, can also include a database for mapping a selected destination to an identified originating phone number.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. Different instances of the word “embodiment” as used within this specification do not necessarily refer to the same embodiment, but they may. The previous detailed description is, therefore, not to be taken in a limiting sense, and the scope of the present invention is defined only by the appended claims.

In the previous description, numerous specific details were set forth to provide a thorough understanding of the invention. However, it is understood that the invention may be practiced without these specific details. In other instances, well-known circuits, structures, and techniques have not been shown in detail in order not to obscure the invention.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Description of Embodiments of the Invention, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of Embodiments of the Invention, with each claim standing on its own as a separate preferred embodiment.

1. A method for sorting facsimiles comprising:
identifying an originating phone number from which the facsimile originates; and
routing the facsimile based on the identified originating phone number.

2. The method of claim 1 wherein routing the facsimile based on the identified originating phone number includes routing the facsimile to an E-mail location.

3. The method of claim 1 wherein routing the facsimile based on the identified originating phone number includes routing the facsimile to a selected output slot on a facsimile device.

4. The method of claim 1 further comprising mapping the originating telephone number to facsimile destination.

5. The method of claim 4 wherein mapping further includes a security level designation for selected originating telephone numbers.

6. The method of claim 4 wherein mapping further includes a confidential designation for selected originating telephone numbers.

7. The method of claim 4 wherein mapping further includes designating a facsimile destination.

8. The method of claim 4 wherein mapping further includes designating a facsimile destination over a web page user interface.

9. The method of claim 8 wherein designating a facsimile destination over a web page user interface includes accessing an embedded web page associated with the facsimile device.

10. The method of claim 1 identifying an originating phone number from which the facsimile originates further comprises reading calling number identification information associated with the originating phone call.

11. The method of claim 1 identifying an originating phone number from which the facsimile originates further comprises reading calling number identification from information transmitted between the first and second ring of the originating phone call.

12. The method of claim 1 identifying an originating phone number from which the facsimile originates further comprises reading a Caller ID associated with the phone call for transmitting the facsimile.

13. A system for sorting facsimiles comprising:
a processor;
a storage device; and
software operable on the processor to:
identify an originating phone number from which the facsimile originates; and
route the facsimile based on the identified originating phone number.

14. The system of claim 13 wherein the software is further operable on the processor to map the originating telephone number to a facsimile destination.

15. The system of claim 13 wherein the software is further operable on the processor to create a database that maps the originating telephone number to a facsimile destination.

16. The system of claim 13 wherein the software is further operable on the processor to create a database that maps the originating telephone number of a facsimile to a plurality of facsimile destinations.

17. The system of claim 13 wherein the software is further operable on the processor to determine a security level associated with the facsimile.

18. A computer-usable storage medium having a computer program thereon for causing a suitably configured information-handling system to sort facsimiles received by a facsimile device by performing the following steps when such program is executed on the system:
identify an originating phone number from which the facsimile originates; and
route the facsimile based on the identified originating phone number.

19. The storage medium of claim 18, wherein the computer program further comprises programming for causing the system, when such program is executed on the system, to perform the following additional step of mapping the originating telephone number to a facsimile destination.

20. A facsimile device comprising:
a processor;
a memory; and
a data reader adapted to identify an originating phone number from data associated with a ring signal.

21. The facsimile device of claim 20 further comprising a mechanism for routing the facsimile based on the identified originating phone number to a selected destination.

22. The facsimile device of claim 20 further comprising a mechanism for routing the facsimile based on the identified originating phone number to at least one selected destination.

23. The facsimile device of claim 20 further comprising a database for mapping a selected destination to an identified originating phone number.
